(19) United States
(12) Patent Application Publication
(10) Pub. No.: US 2005/0138018 A1
(43) Pub. Date: Jun. 23, 2005

(54) Information retrieval system, search result processing system, information retrieval method, and computer program product therefor

(75) Inventors: Dai Sakai, Yokohama-shi (JP); Masami Tada, Sagamihara-Shi (JP); Aya Mori, Yamato-shi (JP); Hirobumi Toyoshima, Tokyo (JP)

Correspondence Address: International Business Machines;Intellectual Property Law, Dept. T81/Bldg. 503, PO Box 12195, Research Triangle Park, NC, 27709, US

(73) Assignee: International Business Machines Corporation, Armonk, NY (US)

(21) Appl. No.: 11/007,552

(22) Filed: Dec. 8, 2004

(30) Foreign Application Priority Data
Dec. 17, 2003 (JP) 2003-419492

(51) Int. Cl. G06F 7/00

(52) U.S. Cl. 707/3

(57) ABSTRACT

To dynamically classify and sort search results according to a natural language query and output the results conveniently, the invention includes an input unit for accepting entry of a natural language query, a natural language processing unit for performing natural language analysis of the query, a search unit for retrieving information using at least one keyword obtained through the natural language analysis, a search result processing unit for analyzing the keyword obtained through the natural language analysis of the query and its modifier, based on semantic content defined in an ontology, and processing the search results of the information retrieval by the search unit, such as sorting and classifying the results, and an output unit.

### TECHNICAL FIELD

The present invention relates to computer technology for information retrieval, and particularly to a technology for presenting information desired by a user from search results in an easy-to-reference format.

### BACKGROUND

With the widespread use of network infrastructure such as the Internet, systems for retrieving information from servers on the network are now becoming widely available (for example, see Japanese Laid-Open Patent Application No. 2002-259418). This type of information retrieval typically involves specifying a keyword as a search condition to obtain information as search results such as web pages containing the keyword or their URLs (Uniform Resource Locators).

To increase the convenience of users, there is also another kind of conventional information retrieval system which performs information retrieval in response to input of a query in natural language (for example, see Japanese Laid-Open Patent Application No. 2002-312389). In such a conventional technique, natural language analysis is performed for identification of the natural language sentence entered, such as morphological analysis and syntax analysis, to extract a keyword and run a query.

Since servers on a network are independent of one another, information retrieval from these servers results in acquisition of a variety of contents and formats of information including the keyword entered. This makes it difficult for a user performing the query to determine which of the search results contains information with contents that actually fit the search criteria, and hence to reach information really desired.

Meanwhile, semantic web technology has been in development in recent years for allowing a computer to deal with semantics, which makes it possible to describe and utilize the semantic contents of information included in web contents or the like using a notational convention called ontology.

Therefore, an approach may be considered that uses an ontology-based semantic statement of information, classifies the results of information retrieval in terms of semantics, and outputs them on an item basis. For example, when a user needs information on a “total rent amount”, it can be calculated from “rent” and “maintenance cost” acquired directly from the information retrieval, and output as a search result if the ontology defines the “total rent amount” as the sum of the “rent” and “maintenance cost”.

Various clustering techniques have been proposed for classifying and presenting search results at user's discretion, such as a method of classifying data searched for a keyword using the keyword matching into a predetermined category, and a method for creating a set of data categorized by the degree of correlation among the data in a vector space (for example, see “Cluster Analysis” by H. C. Romesburg, translated by Hideo Nishida and Tsuguji Sato, and published by Uchida Roukakuho Pub. Co.).

As mentioned above, semantic classification using an ontology or the like is effective to organize the information items of search results in order to output them in a manner so that the user performing the query can easily refer to them.

Users who run queries using search engines on the Internet or the like have various search purposes. Therefore, it is desirable that the information items of search results to be output be classified and sorted depending individually and dynamically on such search purposes. However, in the above-mentioned conventional methods of presenting search results, since data are classified according to predetermined categories, the conventional methods cannot dynamically determine classes and sort the data according to the search query.

### SUMMARY

The present invention may be implemented as an information retrieval system comprising an input unit for entering a query in natural language, a natural language processing unit for performing natural language analysis of the query entered from the input unit, a search unit for performing information retrieval using at least one keyword obtained through the natural language analysis of the query by the natural language processing unit, a search result processing unit for analyzing information related to the keyword obtained through the natural language analysis of the query by the natural language processing unit, based on its predefined semantic content, and processing the results of information retrieval from the search unit based on the analysis results, and an output unit for presenting the search results processed by the search result processing unit.

More specifically, the search result processing unit analyzes a modifier (word(s) or phrase(s)) of the keyword included in the query using an ontology describing the semantic content of the words or phrases to interpret a restrictive condition of the keyword and sort the search results based on the restrictive condition. Alternatively, it may acquire a lower category of the keyword defined in the ontology describing the semantic content of the words or phrases so that the search results from the search unit will be classified by the category.

It is also preferable that after the search results are output from the output unit, the input unit accepts the input of an editing query described in a natural language sentences for the search results, and the natural language processing unit performs its processing on the editing query to extract a modifier of the keyword. Then, the search result processing unit analyzes the modifier using the ontology describing the semantic content of its words or phrases to interpret a restrictive condition of the keyword and sort the search results based on the restrictive condition.

Additionally, the operation may be such that, after the search results are output from the output unit, the input unit accepts the input of data for specifying a specific item from the search results, and the search result processing unit acquires a lower category of the item specified in response to input of data from the input unit and defined in the ontology describing the semantic content of the words or phrases to classify the search results from the search unit by the category acquired so that the output unit can re-output the search results based on the classification results.

Further, the operation may be such that, after the search results are output from the output unit, the input unit accepts the input of data for specifying a specific item from the search results output from the output unit so that the output unit can re-output the search results by making a choice of output items based on the item specified.

In another aspect, the present invention can be implemented as a search result processing system provided with a natural language processing unit and a search result processing unit while using an existing search engine as the search unit.

In still another aspect, the present invention can be implemented as a computer implemented information retrieval method comprising the steps of entering a query in natural language and performing natural language analysis, performing information retrieval using at least one keyword obtained through the natural language analysis of the query, analyzing information related to the keyword obtained through the natural language analysis of the query based on the predefined semantic content, and processing the results of information retrieval based on the analysis results, and outputting the processed search results.

In yet another aspect, the present invention can be implemented as a program for enabling a computer to execute the functions of the information retrieval system or the search results processing system, or to execute processing corresponding to each step in the information retrieval method. This program may be distributed in the form of a magnetic disk, optical disk, semiconductor memory or any other recording medium, or through a network.

According to the present invention constructed as mentioned above, since a keyword and its modifier are extracted from the query to output the search results after sorted and classified based on semantic information obtained through analysis using a collection of semantic statements such as an ontology, the information items of the search results can be classified and sorted dynamically according to the contents of the query, thereby outputting the search results in a format that makes it easy for users to refer to.

In addition, any natural language sentence can be analyzed to derive a search keyword and its modifier in order to perform analysis using the above-mentioned semantic statement. Therefore, input of a query in natural language can be accepted to make possible dynamic classification and sorting of search results based on the query.

### BRIEF DESCRIPTION OF THE DRAWINGS

FIG. 1 is a schematic block diagram showing exemplary hardware structure of a computer suitable for implementing an information retrieval system according to the present invention.

FIG. 2 is a schematic block diagram showing exemplary functional structure of an information retrieval system according to the invention.

FIG. 3 is a flowchart showing the general flow of information retrieval using dynamic sorting according to the embodiment.

FIG. 4 illustrates an example of searched data in the embodiment.

FIG. 5 illustrates an example of an ontology used in the embodiment.

FIG. 6 illustrates examples of a display screen of search results based on the searched data of FIG. 4.

FIG. 7 illustrates another example of the ontology.

FIG. 8 illustrates still another example of the ontology.

FIG. 9 is a flowchart showing the general flow of information retrieval using dynamic classification.

FIG. 10 is a flowchart schematically showing the flow of information retrieval including the process of reediting a display screen.

### DETAILED DESCRIPTION

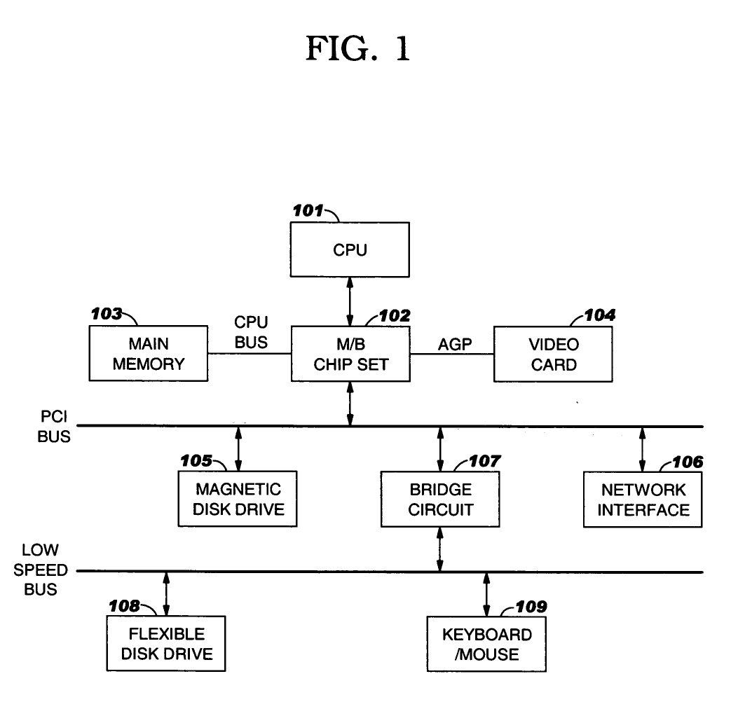

The invention will now be described in detail with reference to the accompanying drawings, wherein FIG. 1 is a schematic block diagram showing an example of the hardware structure of a computer suitable for implementing the information retrieval system according to the embodiment.

The computer shown in FIG. 1 includes a CPU (Central Processing Unit) 101 as computation means, an M/B (Mother Board) chip set 102, a main memory 103 connected to the CPU 101 through the M/B chip set 102 and a CPU bus, and a video card 104 connected to the CPU 101 through the M/B chip set 102 and an AGP (Accelerated Graphics Port). It also includes a magnetic disk drive (HDD) 105 and a network interface 106, both connected to the M/B chip set 102 through a PCI (Peripheral Component Interconnect) bus. It further includes a flexible disk drive 108 and keyboard/mouse 109, both connected to the M/B chip set 102 through the PCI bus via a bridge circuit 107 and a low-speed bus such as an ISA (Industry Standard Architecture) bus.

FIG. 1 is illustrative rather than limiting of the hardware structure of a computer that may be used to implement the invention; any other configuration may be used as long as it is applicable. For example, only a video memory may be mounted instead of the video card 104 and the CPU may process image data. An external storage, such as a CD-R (Compact Disc Recordable) or DVD-RAM (Digital Versatile Disc Random Access Memory) drive, may also be provided through an interface such as an ATA (AT Attachment) or SCSI (Small Computer System Interface).

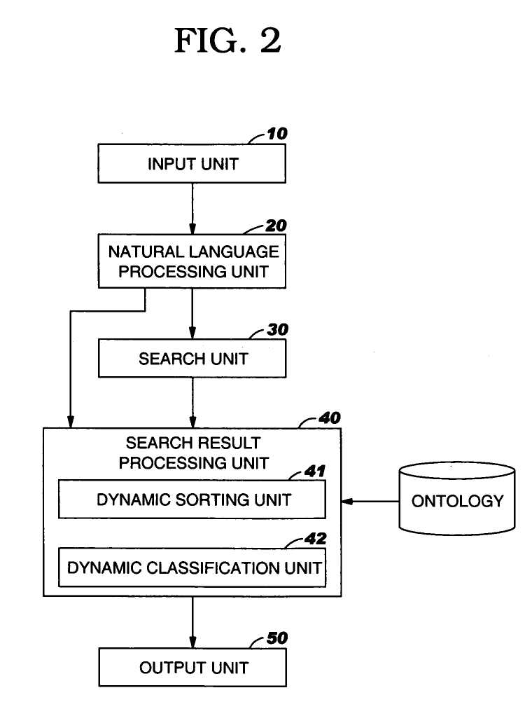

FIG. 2 is an exemplary functional block diagram of the information retrieval system according to the invention.

As shown in FIG. 2, the system may include an input unit 10 for entering a query in natural language, a natural language processing unit 20 for performing the analysis of the query entered, a search unit 30 for retrieving information using at least one keyword obtained through the natural language analysis of the query by the natural language processing unit 20, a search result processing unit 40 for processing search results from the search unit 30, and an output unit 50 for outputting to a display the search results processed by the search result processing unit 40.

In the above-mentioned structure, the input unit 10 is an input device such as a keyboard/mouse 109 shown in FIG. 1. Further, if a query is entered from an external device through a network, the network interface 106 shown in FIG. 1 may be used.

The natural language processing unit 20 may be implemented by, for example, the program controlled CPU 101 in FIG. 1. It performs natural language processing, such as morphological analysis, syntax analysis, and semantic analysis, to extract or derive at least one keyword to be used in the search and its modifier. For the extraction of the keyword and its modifier, the natural language processing unit 20 may use a keyword extraction technique for any existing information retrieval system as long as it accepts input of a query in natural language.

The search unit 30 may be implemented by, for example, the program controlled CPU 101 in FIG. 1 and the network interface 106 of FIG. 1. It performs information retrieval using the keyword extracted by the natural language processing unit 20 accessing one or more servers on the network. The retrieval technique using the keyword may be any technique used for existing information retrieval systems (search engines).

The search result processing unit 40 may be implemented by, for example, the program controlled CPU 101 in FIG. 1. It classifies and sorts the search results from the search unit 30. The processing by the search result processing unit 40 will be described in detail later.

The output unit 50 may be implemented by, for example, the program controlled CPU 101 and the video card 104 in FIG. 1. It creates a display screen showing the search results processed by the search result processing unit 40 so that the display screen will be provided on the display.

The input of a query in natural language is accepted and the results of information retrieval are combined and may be output in the form of a table. In this case, if the query is “I want red-framed glasses”, information on glasses having a red or reddish frame appears at the beginning of the table-format output from among all pieces of information obtained as search results. Similarly, if the query is “I want cheap glasses”, it information on glasses obtained as search results be arranged in order from the cheapest to the most expensive in the table-format output.

The search result processing unit 40 performs its processing, such as classification and sorting, on the search results when combining search result tables to be output. As shown in FIG. 2, the search result processing unit 40 has a dynamic sorting unit 41 and a dynamic classification unit 42 as functions for processing the search results. An ontology describing the semantic content of words or phrases and the relationship with other words or phrases is prepared to perform these functions, and stored in a memory device such as the magnetic disk drive 105 shown in FIG. 1.

The following describes these functions in detail. Dynamic sorting of the search results will first be described.

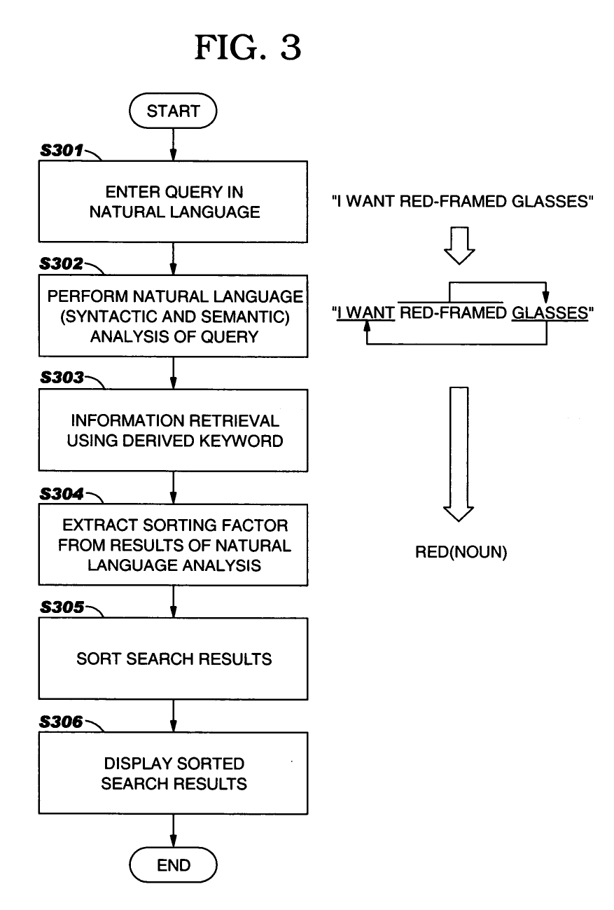

FIG. 3 is a flowchart showing the general flow of information retrieval using dynamic sorting. Referring to FIG. 3, a query in natural language is entered through the input unit 10 (step 301). It is assumed here that the query entered is “I want red-framed glasses”. The natural language processing unit 20 performs syntax analysis and semantic analysis on the query entered from the input unit 10 to analyze a modification relation in the query (step 302). In the above example of “I want red-framed glasses”, “red-framed” is a modifier of “glasses”, and the words “I want” and “glasses” are in a subject-verb-object relation.

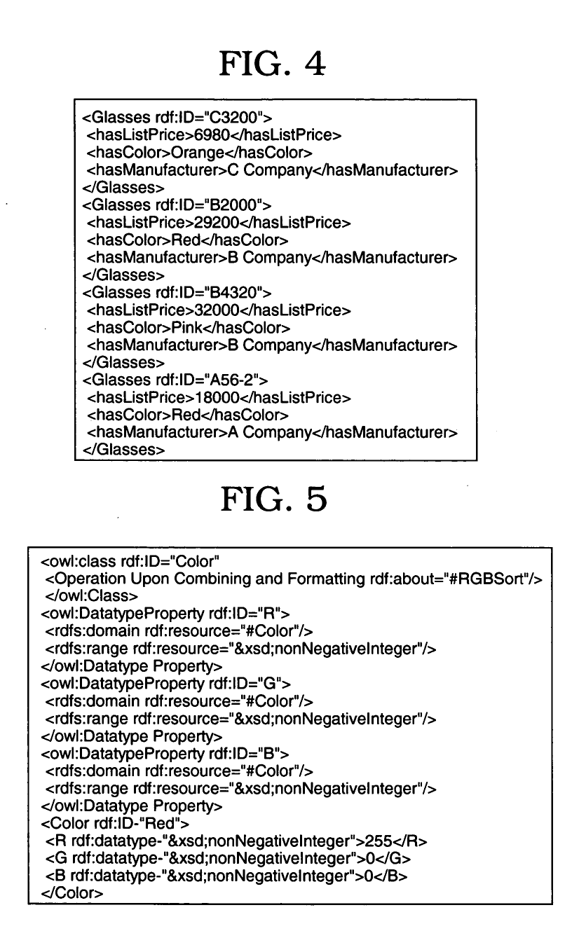

At least one keyword is derived from the query based on this analysis. Next, the search unit 30 searches servers on the network using this keyword and forwards the search results to the search result processing unit 40 (step 303). In the above example, since the word “glasses” which is the object of the query is derived as a keyword, a search is performed using the keyword “glasses”. FIG. 4 shows examples of searched data related to the word “glasses”.

On the other hand, the dynamic sorting unit 41 of the search result processing unit 40 acquires the analysis results of the query from the natural language processing unit 20 to look for a modifier defining a restrictive condition of the keyword and extract a sorting factor used to sort the search results (step 304). In the embodiment, the sorting factor is extracted by the following method.

First, an adjective or adjective verb is converted to a noun form. Specifically, if it is an adjective, the conjugational suffix is changed from the Japanese adjective-forming suffix “-i” to the Japanese noun-forming suffix “-sa”. For example, the Japanese adjective “aka-i” equivalent of the English adjective “red” is changed to “aka-sa” equivalent of the English noun “red” or “redness”. On the other hand, if it is an adjective verb, the conjugational suffix is deleted. For example, “-na” is removed from the Japanese adjective verb “anka-na” equivalent of the English past-participle adjective phrase “low-priced” to produce a Japanese noun “anka” equivalent of the English noun “low-price”. The noun form of the adjective or adjective verb modifying the target to be searched for is thus called the “sorting factor”.

Then, the dynamic sorting unit 41 searches the memory device in which the ontology is stored to look for a class or instance of the sorting factor extracted. It is assumed here that the ontology defines the above-mentioned Japanese noun “aka-sa” equivalent of the English noun “red” or “redness” as shown in FIG. 5. In the example of FIG. 5, “aka-sa” is defined as an instance in a class called “color”.

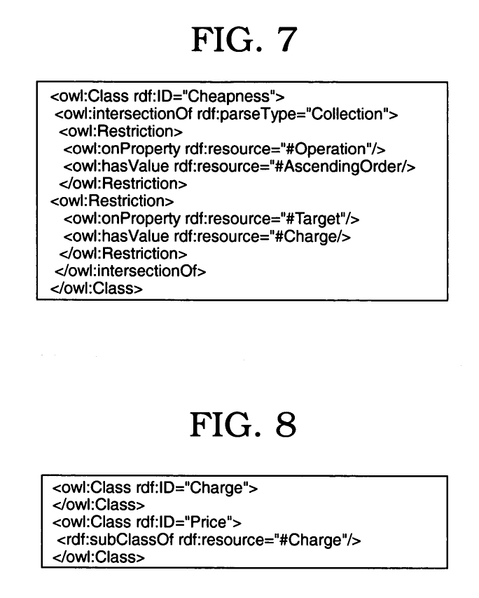

Next, the dynamic sorting unit 41 determines an item to be sorted, and calls a sorting process described in the ontology as “operation upon combining and formatting” in FIG. 5 to rearrange (sort) the search results obtained in step 303 (step 305). It should be noted that there are two cases that the sort factor corresponds to a class or instance in the ontology. If it corresponds to a class, an item described as a target to be sorted in the class (shown as “Target” in FIG. 7) will be a target item to be sorted. On the other hand, if it corresponds to an instance, the class including the instance will be a target item to be sorted. In the example of FIG. 5, since the instance is defined as the Japanese noun “aka-sa” equivalent of the English noun “red” or “redness”, the class “color” including this instance is the target item to be sorted.

The sorting process is to define how to sort the class in which each word defined as the sorting factor in the ontology belongs; it may be preset according to the kind of class. For example, in the case of the class “color” shown in FIG. 5, “RGB sort” indicating a distance from an RGB (Red-Green-Blue) value is set (in the case of the Japanese noun “aka-sa (red)”, a value determining how far it is from the maximum red value, that is, R=255, G=0, and B=0, is set) to arrange the search results in order from the closest to the father. Thus the sorting process and the objects to be sorted are assigned to the class of the sorting factor (or the class of the instance if the sorting factor is an instance). Therefore, if the sorting factor is found in the search results, the sorting process will be automatically called to sort the search results.

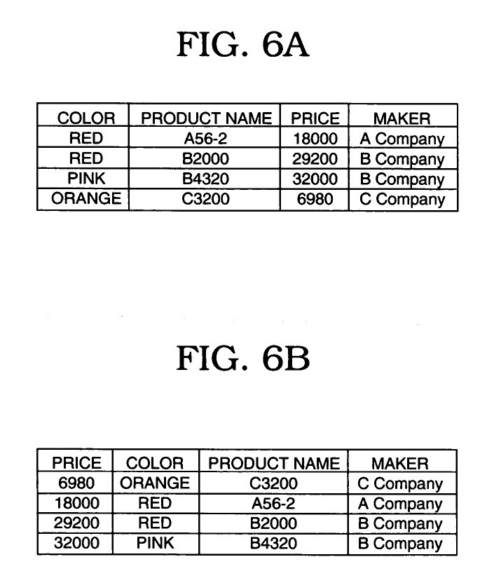

As mentioned above, when the search results are sorted based on the sorting process described in the ontology, the output unit 50 creates a table-form display screen on which the sorting results are reflected, and displays the screen on the display (step 306). FIG. 6 shows examples of display screens based on searched data of FIG. 4. Referring to FIG. 6(A), it can be found that the information on glasses obtained as the search results is arranged in order from the most reddish to the least reddish. The color attribute referred to when arranging the search results is described in the leftmost column, which makes it easy for the user to recognize that the search results are arranged by color.

For example, the use of the dynamic sorting function of the embodiment makes it possible to sort and output the search results (information on glasses) according to the dynamically selected criterion (red color) to the query “I want red-framed glasses”. Needless to say, this dynamic sorting technique may be a general-purpose technique that does not depend on any modifier, such as adjective or adjective verb attached to the word to be searched for.

Suppose here that the query “I want red-framed glasses” replaces “I want cheap glasses”. In this case, the operation is the same until the search for “glasses” is performed in step 303. A different point is that the Japanese adjective “yasu-i” equivalent of the English adjective “cheap” as a modifier of “glasses” is converted to its noun form “yasu-sa” equivalent of the English noun “cheapness” to be extracted as the sorting factor. Then the class or instance corresponding to the sorting factor is searched for from the ontology. It is assumed here that the definition of the class shown in FIG. 7 is described in the ontology for the sorting factor “yasu-sa”. In this case, from the description of the class, “charge” is obtained as a target item to be sorted (target upon combining and formatting), and then “ascending order” is obtained as a sorting process (operation upon combining and formatting). In this case, the search results are arranged in order from the minimum to the maximum charge.

Further, the charge attribute referred to when sorting the search results is described in the leftmost column, which makes it easy for the user to recognize that the search results are arranged by charge.

If the ontology defines that the Japanese noun “yasu-sa” equivalent of the English noun “cheapness,” obtained from the Japanese adjective “yasu-i” equivalent of the English adjective “cheap,” is synonymous with the Japanese noun “anka” equivalent of the English noun “low-price,” obtained from the Japanese adjective verb “anka-na” equivalent of the English past-participle adjective “low-priced,” the same search results will be obtained even through the query “I want cheap glasses” replaces “I want low-priced glasses”.

Further, as shown in FIG. 8, if the ontology defines the word “price” to be a lower class (subclass) of the word “charge,” the search results presented on a charge basis can be sorted according to the sorting process for “charge”. Similarly, if the ontology defines the word “charge” in relation to a “list price”, “cost” and the like, the search results of “charge” presented by reference to these words can be sorted by the sorting process for “charge” in the same way.

On the other hand, if there is no item corresponding to the sorting factor extracted from the query and used to sort the search results (for example, in the case that a query is “I want rapid glasses” and there is no item corresponding to the sorting factor “rapidity”), the search results will be combined, output, and displayed in the form of a table without any sorting.

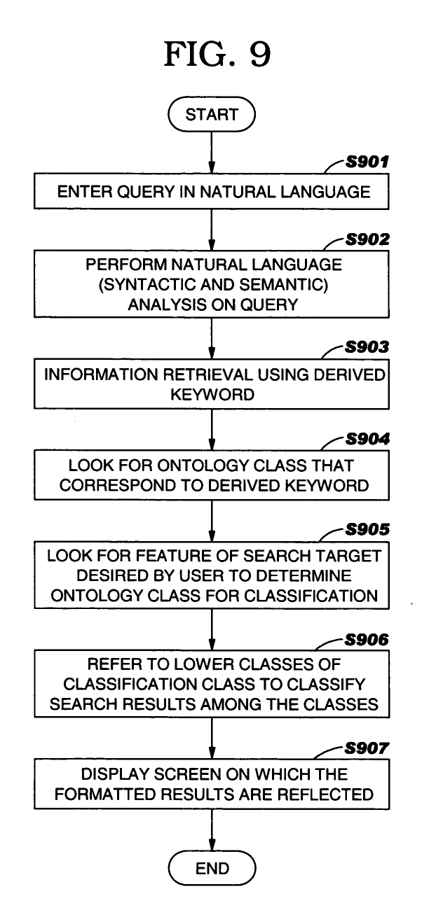

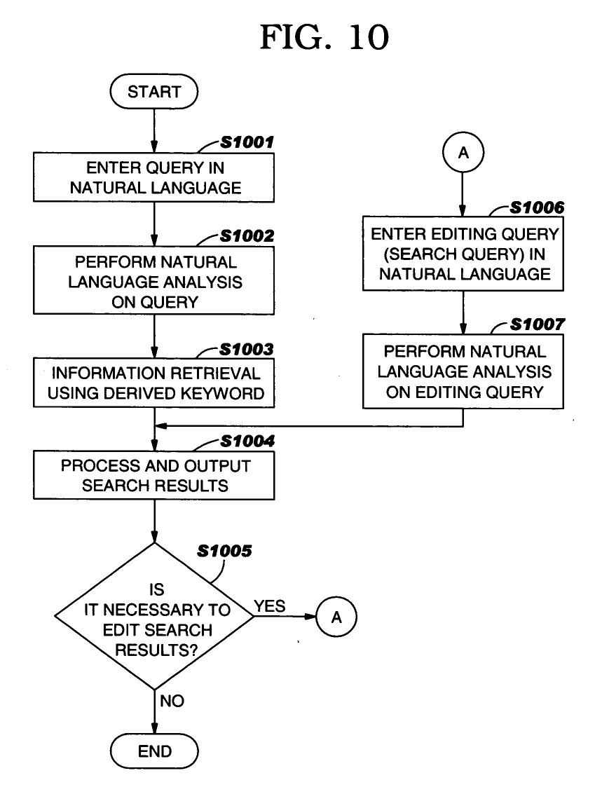

The following describes dynamic classification of the search results. FIG. 9 is a flowchart showing the general flow of information retrieval using dynamic classification.

Referring to FIG. 9, a query in natural language is entered through the input unit 10 (step 901). The natural language processing unit 20 performs syntax analysis and semantic analysis on the query entered from the input unit 10 to analyze a modification relation in the query (step 902). At least one keyword is derived from the query based on this analysis. Next, the search unit 30 searches servers on the network using this keyword and forwards the search results to the search result processing unit 40 (step 903).

On the other hand, the dynamic classification unit 42 of the search result processing unit 40 acquires the analysis results of the query from the natural language processing unit 20 to look for or retrieve a corresponding ontology class from the memory device in which the ontology is stored (step 904).

Next, the dynamic classification unit 42 searches the ontology for the feature of a target item desired by the user based on the modifier of the keyword in the query to determine an ontology class for classification (step 905). The dynamic classification unit 42 refers to a class immediately lower than the class for classification determined from the description of the ontology to classify the search results that match the immediately lower class for classification (step 906).

As mentioned above, when the search results are classified based on the class or feature described in the ontology, the output unit 50 creates a display screen on which the formatted search results are reflected, and outputs the screen to the display (step 907). The classification of the search results may be obtained based on the hierarchical structure of classes in the ontology and, as mentioned above, the embodiment is to achieve the classification using a combination of the semantic analysis by the natural language processing unit 20 and the search using the ontology by the dynamic classification unit 42.

When a query is entered in the form of a natural language sentence, it is considered that the above-mentioned query may replace an alternate phrase with essentially the same meaning. However, if the various words or phrases are defined as properties in the same ontology, the natural language processing unit 20 can determine the properties of the ontology, thereby dealing with all the expressions as the same query.

Since the dynamic sorting function by the dynamic sorting unit 41 and the dynamic classification function by the dynamic classification unit 42 are functions independent of each other, the display screen may be displayed in a table form after performing both functions, or after performing either of the functions. Proper selection of search results according to a target to be searched for makes it possible to output and display an easy-to-refer display screen from which the user can easily find desired information.

As mentioned above, in this exemplary embodiment, since the search results are sorted and classified according to a semantically-related words or phrases even without knowing the category by which the targets to be searched for are classified or the item name by which the information is described, the user can enter a natural language query describing desired conditions to obtain the output of search results classified and sorted in an appropriate manner.

Further, the system can accept an instruction from the user to switch the current display screen to another, so that it will reedit the display screen to obtain more appropriately processed search results.

Typical users may not often know the category by which targets to be searched for are classified or the item name by which the information is described when performing information retrieval. Therefore, in many cases, it is desirable to rearrange the displayed item or change categories to create a new category for classification. Therefore, the output unit 50 accepts any operation to the search results output and displayed on the display through the output device, thus performing the function for editing the output results and switching from the display screen to the edited one.

FIG. 10 is a flowchart schematically showing the flow of information retrieval including reediting of the display screen according to the embodiment. As shown in FIG. 10, an query is entered from the input unit 10 and a search request is originated (step 1001), and through the analysis processing by the natural language processing unit 20 (step 1002), the information retrieval is carried out by the search unit (step 1003). Then, after processed by the search result processing unit 40, the output unit 50 outputs the search results to the display so that they will be displayed on the display (step 1004).

After that, if the user wants to edit the search results, a reediting request can be sent by entering a search query corresponding to a user's desired editing query through the input unit 10 (steps 1005 and 1006). In this case, the user may enter any instruction, other than the search query, such as to specify a display item or to specify a classification item from those displayed on the display screen output in step 1004, to instruct the display to show a category lower than the currently specified category. When the search request including such query is entered, the natural language processing unit 20 analyzes the natural language sentence entered, and the search result processing unit 40 performs processing such as sorting and classification based on the editing query (search query) obtained through the analysis performed in step 1007 on the search results in step 1003. The search results reprocessed according to the editing query are outputted and displayed by means of the output unit 50 (step 1004). Once the desired search results are obtained, the processing is ended (step 1005).

As shown in FIG. 10, a sort query or display item is entered as an editing query by utilizing the first search results from the search unit 30 to rearrange the output, so that it is possible to output the search results in such a manner that the user can easily refer to the desired information.

Further, in the first cycle from step 1001, a search may be performed without any narrowing-down condition using an adjective or adjective verb. In this case, the user can refer to the display screen output in step 1004 to enter a new editing query and re-output the search results. Thus the user can obtain the search results the user really wants.

A query in natural language is accepted in the process of information retrieval, and analysis using an ontology is performed on the query, so that the search results can be sorted or classified according to user's search purpose determined. Therefore, even if the user running the query does not understand in detail the ontology or the information obtained as a result of the information retrieval using the ontology, the search results can be output in a format that suits the user's purpose and makes it easy for the user to refer to.

Further, after the search results are presented to the user, the system can accept the input of an editing query for the search results to perform analysis using the ontology on the editing query in order to determine the user's editing purpose. This allows the system to sort and classify the search results according to the editing purpose. Such a system structure makes it possible to reedit and re-output the search results in a format that suits the user's purpose and makes it easy for the user to refer to even if the user running the query does not understand in detail the ontology or the structure of information obtained as a result of the information retrieval.

1. An information retrieval system comprising:
an input unit for entering a query in natural language;
a natural language processing unit for performing natural language analysis on the query entered from said input unit;
a search unit for retrieving information using at least one keyword obtained through the natural language analysis of the query by said natural language processing unit;
a search result processing unit for analyzing information related to the keyword obtained through the natural language analysis of the query by said natural language processing unit based on predefined semantic content of the information to process the results of the information retrieval by said search unit based on the analysis result; and
an output unit for outputting the search results processed by said search result processing unit.

2. The system according to claim 1, wherein said search result processing unit analyzes a modifier of the keyword included in the query using an ontology describing semantic content to interpret a restrictive condition of the keyword and sort the search results from said search unit based on the restrictive condition.

3. The system according to claim 1, wherein said search result processing unit acquires a lower category of the keyword defined in the ontology describing the semantic content to classify the search results from said search unit by the category acquired.

4. The system according to claim 1, wherein:
said input unit accepts input of a natural language editing query for the search results output from said output unit;
said natural language processing unit performs natural language analysis on the editing query accepted by said input unit;
said search result processing unit uses an ontology describing the semantic content of a modifier of the keyword to perform analysis for the keyword obtained through the natural language analysis of the editing query by said natural language processing unit so as to interpret a restrictive condition of the keyword and sort the search results from said search unit based on the restrictive condition; and
said output unit outputs the search results based on the sorting results by said search result processing unit.

5. The system according to claim 1, wherein:
said input unit accepts input of data for specifying a specific item in the search results output from said output unit;
said search result processing unit acquires a lower category of the item entered and specified through said input unit, the category defined in the ontology describing semantic content, to classify the search results from said search unit by the category; and said output unit outputs the search results based on the classification results by said search result processing unit.

6. The system according to claim 1, wherein:
said input unit accepts input of data for specifying a specific item in the search results outputted from said output unit; and
said output unit outputs search results after making a choice of output items based on the specified item accepted by said input unit.

7. A search result processing system comprising:
analysis means for analyzing a predetermined natural language sentence entered to acquire at least one keyword and information on the keyword;
search result processing means for receiving the analysis results from said analysis means and the results of information retrieval using the keyword, analyzing information related to the keyword on the basis of its semantic content, and processing the search results based on the analysis results; and
output means for outputting the search results processed by said search result processing means.

8. The system according to claim 7, wherein said search result processing means uses an ontology describing the semantic content of a modifier of the keyword to perform analysis for the keyword included in the natural language sentence analyzed by analysis means so as to interpret a restrictive condition of the keyword and sort the search results based on the restrictive condition.

9. The system according to claim 7, wherein said search result processing means acquires a lower category lower of the keyword defined in the ontology describing the semantic content to classify the search results by the category.

10. A computer implemented information retrieval method comprising:
accepting entry of a query in natural language and performing natural language analysis of the query;
retrieving information using at least one keyword obtained through the natural language analysis of the query;
analyzing information related to the keyword obtained through the natural language analysis of the query based on predefined semantic content of the information to process the results of the information retrieval by said search unit based on the analysis result; and
outputting the processed search results.

11. The method according to claim 10, wherein processing search results performs analysis using an ontology describing the semantic content of a modifier of the keyword included in the query, interprets a restrictive condition of the keyword, and sorts the search results based on the restrictive condition.

12. The method according to claim 10, wherein processing search results acquires a lower category of the keyword defined in the ontology describing semantic content of a modifier, and classify the search results by the category.

13. The method according to claim 10, further comprising:
accepting input of an editing query described in natural language, and directed to the search results outputted to perform natural language analysis on the editing query;
performing analysis using an ontology describing semantic content of a modifier of the keyword obtained through the natural language analysis of the editing query to interpret a restrictive condition of the keyword, and sort the search results based on the restrictive condition; and
re-outputting the search results based on the sorting results.

14. A computer program product comprising a computer readable medium having computer readable computer code embedded therein, the computer readable program code comprising:
computer readable program code configured to accept entry of a query in natural language and performing natural language analysis on the query;
computer readable program code configured to retrieve information using at least one keyword obtained through the natural language analysis of the query; and
computer readable program code configured to analyze information related to the keyword obtained through the natural language analysis of the query based on predefined semantic content of the information and to process the results of the information retrieval by said search unit based on the analysis result.

15. The computer program product of claim 14, wherein the computer readable program code configured to process search results enables the computer to perform analysis using an ontology describing semantic content of a modifier of the keyword included in the query, interpret a restrictive condition of the keyword, and sort the search results based on the restrictive condition.

16. The computer program product of claim 14, wherein the computer readable program code configured to process search results enables the computer to acquire a lower category of the keyword defined in the ontology describing the semantic content of the modifier, and classify the search results by the category.

17. The computer program product of claim 14, wherein the computer readable program code further comprises:
computer readable program code configured to output the processed search results;
computer readable program code configured to accept input of an editing query described in natural language and directed to the search results output to perform natural language analysis on the editing query;
computer readable program code configured to perform analysis using the ontology describing the semantic content of a modifier of the keyword obtained through the natural language analysis of the editing query to interpret a restrictive condition of the keyword and sort the search results based on the restrictive condition; and
computer readable program code configured to re-output the search results based on the sorting results.

18. A computer program product comprising a computer readable medium having computer readable computer code embedded therein, the computer readable program code comprising:
computer readable program code configured to accept and analyze natural language to acquire at least one keyword and information on the keyword; and
computer readable program code configured to receive the analysis results and the results of information retrieval using the keyword, analyze the information related to the keyword based on its predefined semantic content, and process the search results based on the results of analysis using the semantic content.

19. The computer program product of claim 18, wherein the computer readable program code configured to process the search results performs analysis using an ontology describing semantic content of a modifier of the keyword included in the natural language analyzed, interpret a restrictive condition of the keyword, and sort the search results based on the restrictive condition.

20. The computer program product of claim 18, wherein the computer readable program code configured to process the search results acquires a lower category of the keyword defined in an ontology describing semantic content of a modifier and classify the search results by the category.
